(19) United States
(12) Patent Application Publication
(10) Pub. No.: US 2007/0117082 A1
(43) Pub. Date: May 24, 2007

(54) Systems, methods and apparatus for monitoring exams

(76) Inventors: Douglas M. Winneg, Boston, MA (US); Joshua William Soske, Vancouver, WA (US)

Correspondence Address: GOODWIN PROCTER LLP;PATENT ADMINISTRATOR, EXCHANGE PLACE, BOSTON, MA, 02109-2881, US

(21) Appl. No.: 11/603,258

(22) Filed: Nov. 21, 2006

Related U.S. Application Data
(60) Provisional application No. 60/738,635, filed on Nov. 21, 2005.

(51) Int. Cl. G09B 3/00

(52) U.S. Cl. 434/350

(57) ABSTRACT

The invention relates to systems and methods for remotely monitoring examinations. Examinations are authored and rules are attributed to the exams that determine how the exams are to be administered. Exam proctors monitor exam takers from remote locations by receiving data indicative of the environment in which the exam takers are completing the exams.

### CROSS-REFERENCE TO RELATED APPLICATION

This application incorporates by reference, and claims priority to and the benefit of, U.S. Provisional Patent Application Ser. No. 60/738,635, which was filed on Nov. 21, 2005.

### FIELD OF THE INVENTION

This invention relates generally to the field of computer-based testing systems, and in particular to systems, methods and apparatuses that facilitate the authentication and remote monitoring of an exam taker, thereby ensuring the integrity of the testing environment and minimizing the possibility of cheating.

### BACKGROUND

As computers become increasingly pervasive in our society, most students and professionals have access to a computer. Further, with the advent of the Internet, wired (or wireless) classrooms and the world-wide-web, educational institutions are now able to provide educational content directly to the students' personal computers in electronic form. Institutions are able to achieve the benefits of computer-based learning and testing without having to provide students or trainees with access to school computers, or in some cases even classrooms.

One example of how computers have become part of the education and training process is computer-based testing (“CBT”). Institutions have adopted CBT systems to make the testing process easier for the students, to facilitate quicker and more accurate exam grading, to provide instant feedback of exam results, to reduce exam preparation time, and to enable the rapid creation of exams from large databases of test questions.

Furthermore, students and teachers have become accustomed to accessing course documentation (e.g., syllabi, learning exercises, virtual chat rooms, digital lesson plans, grade-books) using some form of web-based learning management system or course management system (“CMS”). Such systems have been widely adopted throughout the educational market, and in addition to storing course content, many also provide some form of computer-based testing.

In addition to the efficiencies provided by the use of computers in testing described above, computer-based testing also provides significant logistical benefits over the traditional “pen and paper” and “in-person” testing methods. For purposes of teaching and training, a computer can serve as both a virtual classroom and exam room. With a computer and an internet connection, a student can access materials once accessible only by physically attending class. With the increased use of computers in education, students can “attend” classes, earn degrees and/or attain certifications without physically leaving their job or home. The student's home or work computer act as the classroom by providing both access to the required educational materials and facilitating exam administration. Thus, many schools have been able to increase enrollment without adding classrooms by offering some or all of their classes on-line. Accordingly, various educational institutions (e.g., traditional schools, business that provide training and organizations that provide certifications) can “teach” and “test” students without having to provide a physical classroom or exam room. As a result, learning and testing can take place anywhere, at anytime.

While educational institutions and professional certification organizations have begun to realize the logistical and administrative benefits of CBT systems described above, the dispersive nature of this teaching method has created numerous challenges in the testing process. For example, when remotely administering exams, the identity of the exam taker may need to be authenticated, and the ability of exam takers to cheat should be minimized. While conventional methods of administering exams (e.g., live proctored exams) address these needs, they fail to capitalize on the benefits of computer-based learning described above. Such methods (e.g., requiring exam takers to physically visit a proctored exam room, requiring the exam taker to travel to a computerized-testing facility, or not requiring any security) do not, for example, ensure a secure testing facility, allow exam takers to use their own equipment, or support remote location exam delivery.

Some aspects of addressing these challenges have been addressed by systems that ensure a exam taker cannot use their own computer to cheat, and are described, for example, in commonly-owned U.S. Pat. No. 7,069,586 entitled “Securely Executing an Application on a Computer System” issued on Jun. 27, 2006, the entire disclosure of which is incorporated by reference herein. However, with the increasing reliance on distance and remote learning, what is needed is a technique to extend the currently available computer-based learning applications to facilitate authentication of the exam taker, and remote monitoring of both the exam taker's computer and his environment to ensure the integrity of the testing process.

### SUMMARY

The present invention is directed to methods and systems for authenticating the identity of an authorized exam taker as well as monitoring the exam taker from a remote location. Armed with these abilities, educational institutions are able to permit an individual to take a test from anywhere at anytime, using their own computer, in a cheat-proof environment without requiring the physical presence of exam proctors. Exams can be authored by individuals such as professors, government agencies, licensing bodies, or private companies and made available to students, professionals and even the general public. By attributing authentication and administration rules to each exam, the authors identify activities and/or materials that are permitted during the exam, determine authentication requirements, set monitoring parameters and decide which actions constitute cheating. Proctors can then be assigned to the exam and administer the exam according to these rules. During the administration, data representing the environment and actions of the exam taker is captured and sent to a central location. Thus remotely located proctors can monitor the examination process and ensure the exam takers are abiding by the rules. As such the proctor can be located virtually anywhere, and by viewing images and video streams, log files and listening to audio feeds from various remote locations, she can administer multiple examinations simultaneously.

In one aspect of the invention a method for administering an exam at a remote location includes providing a set of rules governing the distribution and administration of an exam, assigning a proctor to the exam and providing the exam to exam takers, at least one of whom is located remotely from the proctor. The exam taker's identity is authenticated, and during execution of the exam, data indicative of the environment of the exam takers is sent to the proctor, thereby allowing the proctor to monitor the actions and environment of the exam taker's.

The data indicative of the environment of the exam takers may be stored in a central data store, and in some cases analyzed (in real-time, post-exam or in some cases both) to detect improper behavior during the examination. In some cases, a remote exam monitoring device that captures video, audio and/or still images of the exam takers environment may be provided to the exam takers. The device may include a camera (still and/or video), a microphone, and in certain embodiments an optical character recognition scanner for scanning and recording bar codes. The device may also include a biometric capture device (e.g., a fingerprint reader, retina scanner and/or a facial scanner) to capture and transmit biometric authentication data.

The environment data may be captured in real time, continuously, and/or periodically. The data may include log files or other data based on activities on a computer being used by the exam taker. If captured periodically, the periodicity may be random, scheduled, in response to a trigger event, or any combination thereof. Examples of trigger events may include actions taken by one of the exam takers, audio signals (e.g., a voice or telephone ring), or computer-based events.

In another aspect, a system for remotely administering an examination includes an examination authentication services module for authenticating users of the system and an examination builder module for defining exam rules and exam meta data for the exam. The examination authentication services module also provides the examinations to the remote exam takers in response to a request for an examination (or instructions from the exam author). Upon authentication of the exam takers, an examination monitoring services module receives data describing the environment of the remote exam takers, and facilitates the administration the exam from a location other than that of the remote exam takers.

In various embodiments, a data storage module may be used to store the received data, the exams, and/or the rules pertaining to the exams. The system may also include an exam analysis services module for analyzing the received data to detect improprieties during the administration of the examination. A remote exam monitoring device may also be provided to exam takers for collecting the environment data.

These and other objects, along with the advantages and features of the present invention herein disclosed, will become apparent through reference to the following description, the accompanying drawings, and the claims. Furthermore, it is to be understood that the features of the various embodiments described herein are not mutually exclusive and can exist in various combinations and permutations.

### BRIEF DESCRIPTION OF THE DRAWINGS

The following drawings are not necessarily to scale, emphasis instead being placed generally upon illustrating the principles of the invention. The foregoing and other features and advantages of the present invention, as well as the invention itself, will be more fully understood from the following description of exemplary and preferred embodiments, when read together with the accompanying drawings, in which:

FIG. 1 is a block diagram of an embodiment of a system according to the invention.

FIG. 2 is an illustration of various components and data flows that facilitate the remote administration of an examination in accordance with one embodiment of the invention.

FIG. 3 is a summary-level flow chart of the general steps for remote administration of an examination in accordance with one embodiment of the invention.

FIG. 4 is a more detailed flow chart of the steps for remote administration of an examination in accordance with one embodiment of the invention.

FIG. 5 is a schematic perspective view of a monitoring apparatus in accordance with one embodiment of the invention.

FIGS. 6A-6D are schematic front, rear, side, and top views respectively of the apparatus of FIG. 5.

FIG. 7 is a schematic cross-sectional view of the apparatus of FIG. 5 taken at line 7-7 in FIG. 6D.

FIGS. 8A and 8B are graphical representations of the viewable range about an exam taker of the monitoring apparatus at different settings.

FIG. 8C is a tabular representation of various parameters of the size and orientation of a monitoring device in accordance with various embodiments of the invention.

FIG. 9 is a flow chart depicting a method of remotely monitoring the administration of an exam in accordance with one embodiment of the invention.

### DETAILED DESCRIPTION

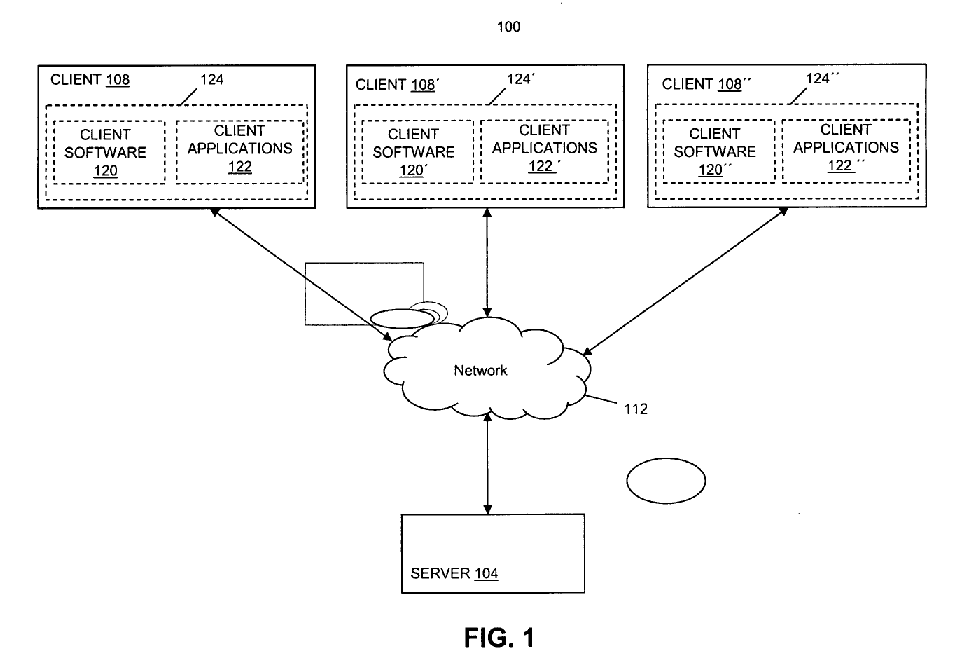

Referring to FIG. 1, in one embodiment, a remote examination administration system 100 includes at least one server 104, and at least one client 108, 108′, 108″, generally 108. As shown, the system 100 includes three clients 108, 108′, 108″, but this is only for exemplary purposes and in actual implementation there can be any number of clients 108 distributed among the various users of the system 100. The client 108 is preferably implemented as software running on a personal computer (e.g., a PC with an INTEL processor or an APPLE MACINTOSH) capable of running such operating systems as the MICROSOFT WINDOWS family of operating systems from Microsoft Corporation of Redmond, Wash., the MACINTOSH operating system from Apple Computer of Cupertino, Calif., and various varieties of Unix, such as SUN SOLARIS from SUN MICROSYSTEMS, and GNU/Linux from RED HAT, INC. of Durham, N.C. (and others). The client 108 may also be implemented on such hardware as a smart or dumb terminal, network computer, personal data assistant, wireless device, information appliance, workstation, minicomputer, cellular telephone, mainframe computer, or other computing device that is operated as a general purpose computer or a special purpose hardware device solely used for serving as a client 108 in the remote exam administration system 100.

A communications network 112 connects the client 108 with the server 104. The communication may take place via any media such as standard telephone lines, LAN or WAN links (e.g., T1, T3 , 56 kb, X.25), broadband connections (ISDN, Frame Relay, ATM), wireless links, and so on. Preferably, the network 112 supports TCP/IP protocol communications, and HTTP/HTTPS requests made by a web browser or other client-based software application and the connection between the client software 120 and the server 104 can be communicated over such TCP/IP networks. The type of network is not limited, however, and any suitable network may be used. Typical examples of networks that can serve as the communications network 112 include a wireless or wired Ethernet-based intranet, a local or wide-area network (LAN or WAN), and/or the global communications network known as the Internet, which may accommodate many different media (e.g., video, still photos, audio and data files) and protocols.

Generally, clients 108 are operated by users of the system to author, distribute, take, monitor and/or analyze an examination. In various embodiments, the client computer 108 includes client applications 122, client software 120, or both. One example of a client application 122 is a web browser application that allows the client 108 to request a web page (e.g., from the server 104 or a server operated by another company or individual) with a web page request. An example of a web page is a data file that includes computer executable or interpretable information, graphics, sound, text, and/or video, that can be displayed, executed, played, processed, streamed, and/or stored and that can contain links, or pointers, to other web pages. Other examples include electronic mail applications, as well as custom-developed desktop applications. In one embodiment, a user of the client 108 manually requests a web page from the server 104. Alternatively, the client 108 automatically makes requests with the web browser. Examples of commercially available web browser software are INTERNET EXPLORER, offered by Microsoft Corporation of Redmond, Wash., NETSCAPE NAVIGATOR, offered by AOL/Time Warner of Mountain View, Calif. and FIREFOX by the Mozilla Corporation of Mountain View, Calif.

In some embodiments, the client 108 also includes client software 120. The client software 120 may, for example, include remote exam client access module software that allows a user to author, take and/or monitor examinations as described herein. The client software 120 may be implemented in various forms. For example, it may be in the form of a Java applet that is downloaded to the client 108 and runs in conjunction with one or more client applications 122. The client software 120 may be a standalone application written in C/C++, C#, Java or other appropriate client programming language. The client software 120 may be in the form of an application plug-in written in Visual Basic, javascript, C/C++, or C# that operates within a client application 122. In some embodiments, the client application 122 may be implemented as an information screen within a separate application using, for example, asynchronous JavaScript and XML (“AJAX”) such that many of the user-initiated actions are processed at the remote site using data files asynhcornously transmitted to the client. Further, the client software 120 may be in the form of a standalone application, implemented in a multi-platform language such as Java, in a Net Framework language such as C#, or in native processor executable code. In one embodiment, if executing on the client 108, the client software 120 opens a network connection to the server 104 over the communications network 112 and communicates via that connection to the server 104. The client software 120 and the web browser may be part of a single client-server interface 124; for example, the client software can be implemented as a “plug-in” to the web browser. The web browser is but one possible example of a client application, and others may include word processors, spreadsheets, operating system extensions, email clients, custom or commercially developed content management systems and course management systems, as well as others.

In some instances, a remote exam monitoring device (described below) is connected to one or more of the clients 108, and uses the data communications capabilities of the client 108 to send and receive instructions and/or data from the server 104.

In some embodiments, an administrator operates the server 104, which provides exams and data access to the clients 108 upon request. In some embodiments, the server 104 operates without intervention from an administrator, for example, by executing chron jobs at periodic intervals, or executing batch routines based on the detection of operational occurrences such as equipment failures, power surges, or other monitored events. The server 104 is preferably implemented on one or more server class computers that have sufficient memory, data storage, and processing power and that run a server class operating system (e.g. SUN Solaris, GNU/Linux, MICROSOFT WINDOWS 2000, and later versions, or other such operating system). Other types of system hardware and software than those described herein may also be used, depending on the capacity of the device, the number of users and the number of exams being administered. For example, the server 104 may be part of a server farm or server network, which is a logical group of one or more servers. As another example, there may be multiple servers 104 that may be associated or connected with each other, or multiple servers may operate independently, but with shared data. As is typical in large-scale systems, application software could be implemented in components, with different components running on different server computers, on the same server, or some combination.

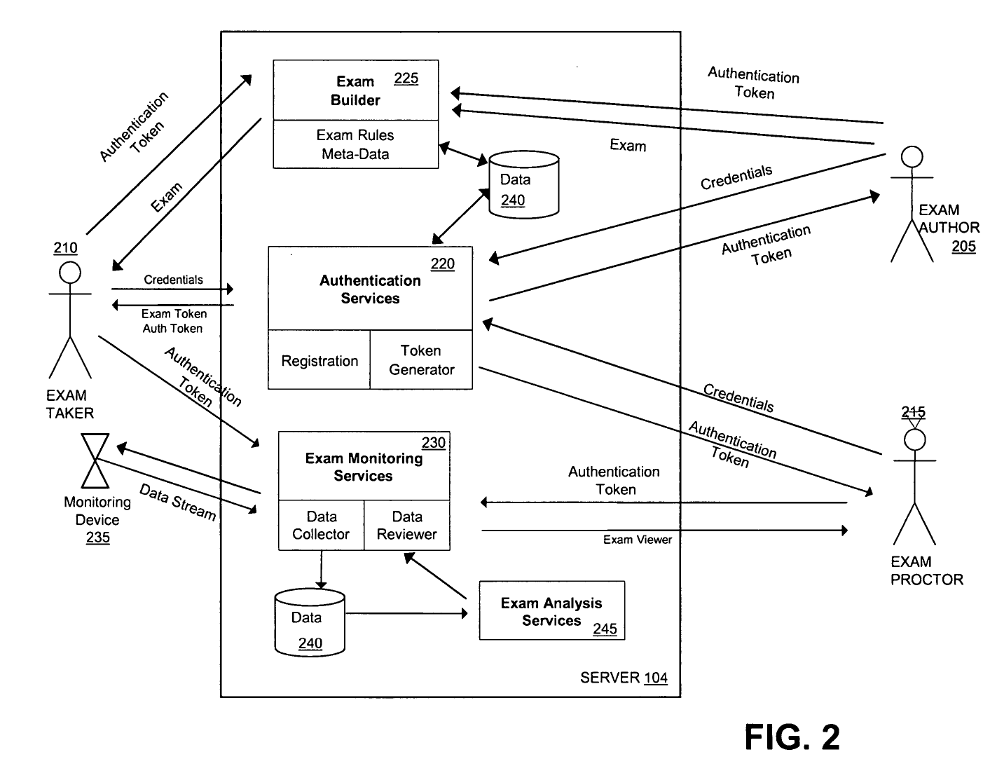

Referring to FIG. 2, an exam author 205, one or more exam takers 210 and in some embodiments one or more exam proctors 215 (who may be the same person as the exam author 205 or a separate individual) use the various components of the system in such a manner as to allow educational institutions (e.g., schools, universities, certification authorities, testing centers, governmental authorities, etc.) to use existing CMS systems while ensuring proper authentication, security and administration procedures are maintained. As a result, the exam taker 210 is able to take an exam using her own computer, from any location, at anytime.

The exam monitoring system acts as an information stream collection gateway between exam takers 210, the exam authors 205 and/or designated proctor(s) 215 administering the exam, as well as the functional modules of the system that implement the application logic and authentication services to facilitate remote exam administration. In some implementations the exam monitoring service is provided to the institutions as software for installation within their network of systems, whereas in other implementations the software may be provided as a service. In such a case, the software may be hosted by a third party (commonly referred to as an application service provider, or ASP), thus allowing multiple institutions to use the services simultaneously without having to install and maintain the software at each institution.

Initially, users register with the system and are assigned one or more roles within the system by providing information to an authentication module 220. Based on these roles, users receive configuration information (e.g., which CMS is to be used to administer the exam, which areas within the CMS should or should not be accessible during the exam, etc.). In one embodiment, the configuration information is stored in encrypted format on the user's local hard drive. In other embodiments, the information is stored on a portable token (e.g., a USB-connected device, wireless device, etc.) that is distributed to the users accessed by the application when invoked. By storing the registration data on the token, users can attach the token to any client (via a USB port, for example) on which the client software has been installed and complete an authorized exam.

Exam authors register to use the system by supplying information such as name, social security number, university ID number, institution, email, etc. and are designated as faculty (or exam author, or some other supervisory role) based on user roles as defined in the system. Once registered and authenticated, faculty members access an exam builder module 225 and an exam monitoring services module 230 to create and monitor exams, respectively. Similarly, exam takers provide student identification information, user information and/or biometric information to be used as authentication criteria for subsequent sessions. Once the user confirms that the registration information is correct, it is transmitted to the authentication service module 220 for storage and subsequent retrieval. In some embodiments, the information is transmitted and/or stored in encrypted format, using, for example, the NIST AES Rijandael standard.

In one exemplary implementation, installation of remote exam access software on an exam taker's client facilitates communication with the authentication services module 220. One function of the authentication services module 220 is to validate users in response to a request to use the system. For example, users may be issued one or more user credentials (e.g., an ID/password paring, a security token, etc.). The authentication services module 220 compares the presented credential with a stored credential, and if they sufficiently match, issues an authentication token. In other embodiments, The interaction between users and the authentication services module 220 may include the provision of a serial number and/or a product key either when the client software was issued by the institution or as part of a download installation procedure from the institution's web page. As two non-limiting examples, the serial number may be used to confirm that the software was received from a proper issuing authority by requiring that the serial number be entered when the software is initiated, or in some cases, each time the software is used. In some instances in which the user provides personal authentication information (e.g., a password, student ID number, social security number, etc.) the system confirms that the user is in fact associated with the institution administering the exam. Additional authentication information collected during the registration process may include a login ID, name, address, email and contact information. In some cases biometric information such as fingerprint, retina scan, facial scan and/or voiceprint may be collected and used as authentication credentials.

In some cases, exams can be administered and monitored by proctors 215, who may or may not have been involved in the authoring of the exam, and may or may not be related to the educational institution administering the exam. Unlike conventional exam proctoring methods in which the proctor must be in the same physical location as the exam taker, the centralized exam monitoring services module 230 allows remote proctors to simultaneously administer multiple (often different) exams to multiple exam taker 210 located virtually anywhere, and do so without having to be in the presence of the exam taker.

Like an exam author, the proctor 215 registers using authentication information similar to the information collected for exam authors 205 and exam takers 210, and is designated as a proctor by a system administrator, author, or designated representative of the educational institution and assigned one or more exams to proctor. In some cases where a third party (i.e., a for-profit exam administration company) administers the exams, a proctor can be selected from a group of pre-authorized proctors. A faculty member, author and/or the local system administrator may approve a registered proctor for proctoring a specific exam.

The exam monitoring services module 230 communicates with a remote exam monitoring device 235 (described in greater detail below), receives data representing the environment and activities of the exam taker, and permits exam proctors to view and interact with the data. The data may be received continuously or in discrete files and in either synchronous or asynchronous modes. The data may also be a combination of video and audio, or include separate data feeds for different types of data. In some instances in which the monitoring device includes radio frequency identification or optical character recognition devices, the data may also include confirmation that a particular item is in the vicinity of the monitoring device 235. In some embodiments, exam monitoring services module 230 will not allow the exam taker to begin the exam until and unless the monitoring device 235 is attached to the client machine and in contact with the monitoring services module 230, and/or authenticated using one or more authentication tokens.

The data received from the monitoring device 235 may be stored in a database 240 for subsequent review and analysis using an exam analysis services module 245. For example, the proctor 215 may be monitoring numerous exams simultaneously, and not notice that an individual exam taker is cheating by looking at a book just outside the field of view of the monitoring device 235. However, while reviewing the results of the exam, the proctor 215 (or, in some instances the exam author 205) may notice certain irregularities in the exam scores, such as an unusually high score by a particular exam taker, or that another exam taker completed the exam in far less time than others. Using the monitoring services module 230, the proctor can review the data in greater detail (e.g., in slow motion, stop-frame, in conjunction with audio and/or software log files received from the exam taker's 210 client) to determine if in fact cheating occurred. The proctor 215 may also annotate the data to provide notes and instructions to the exam author about a particular event or questionable activity during the exam.

In some embodiments, the database 240 may also store the exams themselves, user and authentication information, as well as rules for exams (described in greater detail below). The database 240 provides data to the exam builder module 225, the authentication services module 220, and the exam analysis services module 245 as requested by the application commands stored thereon, and also stores data received from these modules. Examples of commercially-available database systems that may be used to implement the database 240 include the MySQL Database Server by MySQL AB of Uppsala, Sweden, the PostgreSQL Database Server by the PostgreSQL Global Development Group of Berkeley, Calif. or the ORACLE Database Server offered by ORACLE Corp. of Redwood Shores, Calif. The database may include various types of storage devices, such as VCRs, DVRs, RAID arrays, USB hard drives, optical disk recorders, flash storage devices, image analysis devices, general purpose computers, video enhancement devices, de-interlacers, scalers, and/or other video or data processing and storage elements for storing and/or processing video. The video signals can be captured and stored in various analog and/or digital formats, including, as examples only, Nation Television System Committee (NTSC), Phase Alternating Line (PAL), and Sequential Color with Memory (SECAM), uncompressed digital signals using DVI or HDMI connections, and/or compressed digital signals based on a common codec format (e.g., MPEG, MPEG2, MPEG4, or H.264).

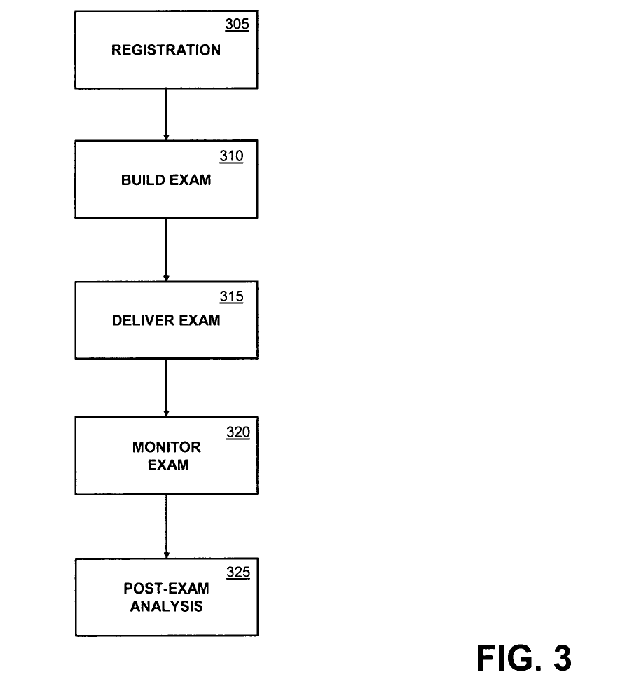

Referring to FIG. 3, the process for authoring, publishing and administering an exam using the system described above includes five general phases—the registration phase (305), the exam build phase (310), the exam delivery phase (315), the exam monitor phase (320) and the post-exam analysis phase (325). Each phase is discussed in greater detail below.

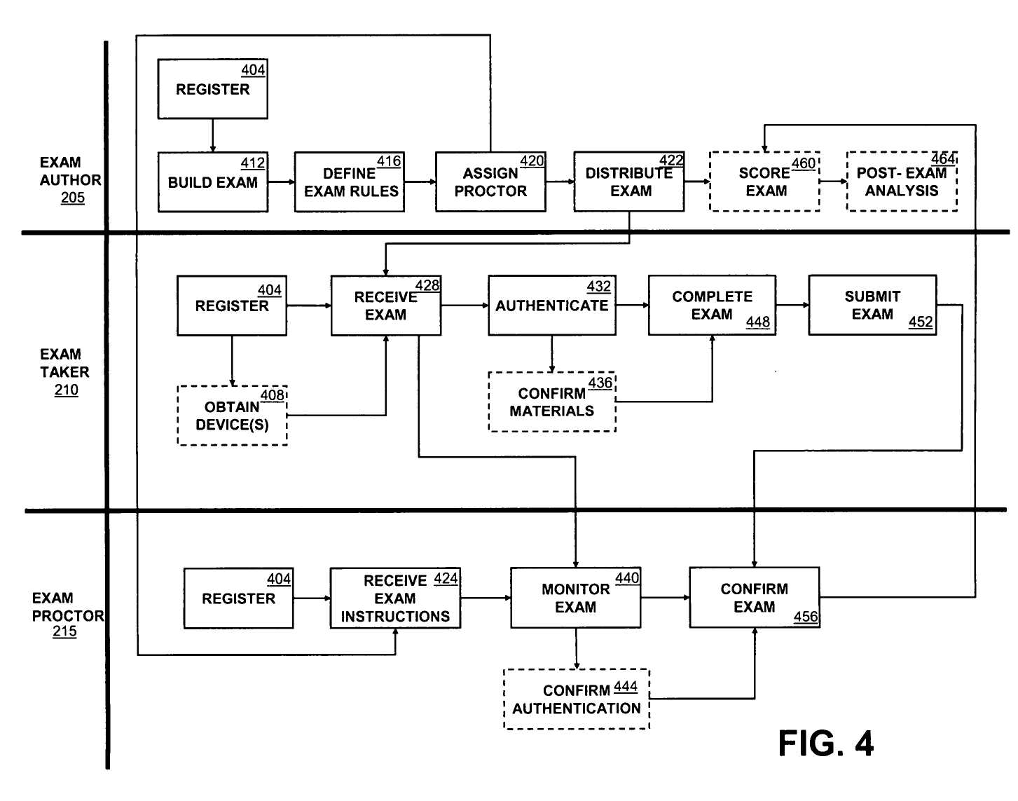

Referring to FIG. 4, exam authors 205 (e.g., professors, faculty members, teaching assistants, etc.), exam takers 210, and in some embodiments exam proctors 215 each register (STEP 404) as users of the system. The registration process may, for example, include the installation of client-based software, or in web-based applications the provision of uniquely identifiable authentication criteria. In some cases in which the exam taker 210 will be taking exams remotely using their own computer, the exam taker 210 may also obtain a remote-monitoring device (STEP 408) as described in greater detail below. Each user may then be authenticated for each subsequent login using their user credentials and or security tokens.

To build a new exam, an exam author 205 logs into the system and provides her user credentials. Once authenticated by the authentication services module, the exam author 205 uses the exam builder module to build the exam (STEP 412). In one embodiment, the exam builder module tracks and records user interactions such as keystrokes, menu selections and/or mouse clicks in an attempt to determine when the author wishes to publish the exam, including an option to approve the exam for “remote proctoring”. For example, as an exam author completes the exam building process in a CMS system used by the institution, the exam builder module recognizes certain steps (e.g., assigning a password to the exam, indicating the exam is to be remotely administered, etc.) and triggers the system to present the author with various options for publishing the exam.

The exam author defines rules (STEP 416) that govern how the exam is to be distributed and/or administered. The rules may include, for example, security settings to be followed during the administration of the exam, such as when and how often to retrieve biometric data from the exam taker 210, when and how often to capture audio and/or video of the exam taker 210 and his environment, the resolution and viewing angle of the video captured, whether or not to capture log files from the exam taker's computer, which applications or URLs the exam taker 210 can access during the exam, any books or materials that are allowed as references during the exam, as well as others. In some embodiments, rules can be dynamically adjusted (either automatically by the system or manually by a proctor who has sufficient privileges) due to bandwidth constraints, network traffic, and other system considerations in order to achieve a balance between image capture frequency and system load. In addition, the author can indicate how the system should react should there be a disruption in communications between the client application on the exam taker's local machine and the exam monitoring service, such as terminating the exam, pausing the exam, requesting re-authentication, or continuing for some period of time.

Exam rules may also relate to user authentication and/or exam-specific administration and monitoring. Examples of authentication-based rules include biometric authentication such as the provision of fingerprint scans from an exam taker using a scanner (which may or may not be integrated into the monitoring device) which may then be compared to a previously received scan on file. Other examples of biometric authentication include voiceprints, retinal scans and facial scans, each of which may be used individually or in combination to authenticate a user.

In addition to creating rules for the exam, the exam author may create one or more passwords for protecting/encrypting the exam. The rules and passwords for the exam can be stored in the database for subsequent retrieval when the exam is delivered, or when the author determines a change to the rules are warranted. In some embodiments, the rules are delivered with the exam to the exam taker 210 upon authorization, and applied at the exam taker's client machine during exam administration.

If the exam author wishes to change one or more of the rules pertaining to an exam (or, in some cases, a group of exams) the author logs into the exam builder module and is presented a list of previously defined exams stored on the system. If the author has appropriate access privileges, the rules are presented in editable form and can be changed as needed. In instances in which a proctor or exam taker logs in and views an exam, the rules may be visible, but presented in read-only form. In some cases, certain rules may not be made viewable at all. When the author is finished editing the rules, the changes are confirmed and saved to the exam builder module.

In some embodiments, the exam author 205 may assign a proctor to an exam (STEP 420). The exam proctor 215 may be affiliated with the institution to which the exam author belongs (e.g., a graduate student at the same university) or in some cases may be an employee or contractor at a third-party exam administration entity such as the THOMSON PROMETRIC Testing and Assessment Services from THOMSON CORPORATION of Stamford, Conn. With an exam completed and a proctor assigned, the exam author 205 distributes the exam (STEP 422) to the exam takers 210. In some cases, the exam author 205 may “publish” the exam by indicating the exam in available to exam takers, whereas in other instances the author 205 may cause copies of the exam (and its associated rules) to be sent to individual exam takers.

Continuing with FIG. 4, the exam proctor 215 logs on to the system and, once authenticated, is presented with a list of exams he has been authorized to proctor. Upon selecting an exam from this list, he is presented with exam instructions (STEP 424) and the current status of the exam. Examples of status information displayed includes the number of exam takers currently using the system that are associated with that proctor (either taking an exam or otherwise), the number of exams that have been completed and the status of each exam (e.g., not started, in progress, completed and awaiting review, reviewed, etc.).

Similarly, exam takers 210 log in to the system and provide authentication credentials (STEP 232) to confirm their identity to the system. In embodiments in which the exam author has approved the use of materials during the exam (e.g., an open-book exam), the exam taker 210 confirms the materials (STEP 436) by, for example, holding a book within the field of view of the monitoring device. The exam proctor 215 may then visually confirm that the book is correct, or in some cases in which the monitoring device includes an optical scanning device, a barcode or other visual identifier is scanned and confirmed using the rules.

While the exam takers are currently taking one or more exams, the proctor monitors one or more exams (STEP 440) by selecting a “View Activity” option, which provides the proctor with thumb-nail images (still pictures, video, or both) of each exam taker (or some subset thereof) taking their exams. In some cases, the proctor may also confirm the exam taker's identity and/or authentication credentials (STEP 444). To view an individual exam taker, the proctor can select an image representing that particular exam taker, enlarge the image, view the image at a higher screen resolution and/or move the field of view of the camera if, for example, the exam taker 210 has left the area. If the data indicates an exam taker has attempted to access unauthorized materials (e.g., books, notes, a web site, etc.), or the proctor notices other suspicious behavior that may indicate an attempt to cheat, the proctor may tag the exam (or a particular time of the exam), insert a flag for future analysis, annotate the data with text, send a message to the exam taker and/or terminate the exam.

In addition to reviewing live data of current exam takers and their environment, proctors may also control the video and/or audio during playback using common VCR-like functions such as fast-forward, rewind, pause, and slow motion to view an exam taker's session. Other capabilities include sending and/or receiving messages from the student (using, for example, email, instant messaging, voice over IP, or other similar means), changing the monitoring options such as the preferred screen resolution, preferred frames-per-second capture rate, and requesting that the exam taker re-authenticate themselves using, for example one or more biometric credentials. In some embodiments the exam monitoring device supports the Direct Show API, allowing the proctor to change the preferred video resolution levels and frame capture rates.

In some cases (due to bandwidth constraints, for example) it may not be possible to view live, streaming video data of every exam taker. If so, the monitoring preferences (e.g., periodicity, audio and video or video only, etc.) may be used as “goals” that the system will attempt to achieve. The system may, in such instances, optimize the allocation of bandwidth, processing power, and other system resources in such a manner to maximize coverage. For example, the exam monitoring services module, having the preferred session settings as a goal (for example, n frames per second from each of 5 exams being monitored by an individual proctor), calculates the throughput of a small data packet from the server to the client software and back at periodic intervals. This measuring process enables the server to calculate a theoretical maximum data throughput available to each connected client and combine the theoretical throughput of data from the various clients with the server's processing load to determine if some clients can be “throttled” by issuing a command to reduce the data transmission rate, or conversely, request that the client increase transmission rates where possible to capture more data.

The exam taker 210 then completes the exam (STEP 448) and submits the exam (STEP 452) for grading and analysis. The exam proctor then confirms (STEP 456) that the exam has been completed and the exam taker 210 that initiated the exam is the same individual that submitted the exam. The confirmation step may also include a preliminary review of the examination process, such as scanning the video and audio files to confirm that no cheating took place.

Once submitted, the exam is scored (STEP 460). The exam may be scored by the exam author 205, or in alternative embodiments by the proctor 215, or automatically scored. Additional post-exam analysis (STEP 464) may then be performed to identify suspicious behaviors that may not have been noticed during exam administration. For example, if a particular exam (or exams distributed to a particular set of individuals) is constantly being scored exceptionally high, the exam analysis services module may be used to further identify suspicious behaviors.

For example, the exam analysis services module adaptively learns which behaviors are suspicious (based, for example, on a human proctor's previous indications) and annotates the audio and/or video data with flags indicating suspicious behavior for the proctor to investigate. For example, a proctor may note that a telephone ringing during an exam should be flagged as a suspicious activity because this may indicate that the exam taker is asking for assistance on the exam. The specific sound profile of the telephone ring can then be added to the rules as a triggering event that starts the audio/video capture or sends an alarm to the proctor. In situations where an exam is being administered without a live proctor reviewing the video in real-time, a ringing phone may trigger a rule (e.g., no calls during the exam) and place a flag at that point in the data stream for future review.

In some embodiments, the system includes filters that can be customized as part of exam-specific rules, institution-specific rules or both. These filters establish thresholds that initiate the transmission of video and/or sound to the monitoring module. In this way, the system does not need to receive a constant stream of video and audio, but will rather only send “suspicious” behavior that should be reviewed by the exam proctor.

In one implementation, the filters stores video and audio at the exam taker's client, and when a threshold is exceeded, it starts transmitting the data out of a data buffer on the client until the activity again is below the threshold. The filters may also be used to sense network connectivity and transmits suspicious video and audio either in a thumbnail image, and change to full video once the connectivity supports the additional data.

One example of the filters is a motion detection filter that uses the Microsoft DirectShow transform filter that looks for motion in an input video stream and modifies the frames to highlight the motion, while sending events to the calling program when new motion is detected and after no motion has been seen for a predetermined time.

Filters can also have parameters which can be preset and/or modified during the rule definition process, such as a motion detection threshold that controls the sensitivity of the motion detection filter. In one example, the threshold is an integer between 1 and 255, and represents the larges largest difference in grayscale values of two pixels being compared across frames. If the difference between frames is larger than the threshold, that area is then flagged as indicating motion.

In some embodiments, the methods and techniques of the present invention described herein may be implemented in hardware or software, or a combination of both on a general-purpose computer. In such an embodiment, the program may be written in any one of a number of high-level languages, such as FORTRAN, PASCAL, C, C++, C#, Java, Tcl, or BASIC. Further, the program can be written in a script, macro, or functionality embedded in commercially available software, such as EXCEL or VISUAL BASIC. Additionally, the software may be implemented in an assembly language directed to a microprocessor resident on a computer. For example, the software can be implemented in Intel 80×86 assembly language if it is configured to run on an IBM PC, APPLE MACINTOSH, or PC clone. The software may be embedded on an article of manufacture including, but not limited to, “computer-readable program means” such as a floppy disk, a hard disk, an optical disk, a magnetic tape, a PROM, an EPROM, or CD-ROM.

Remote Exam Monitoring Device

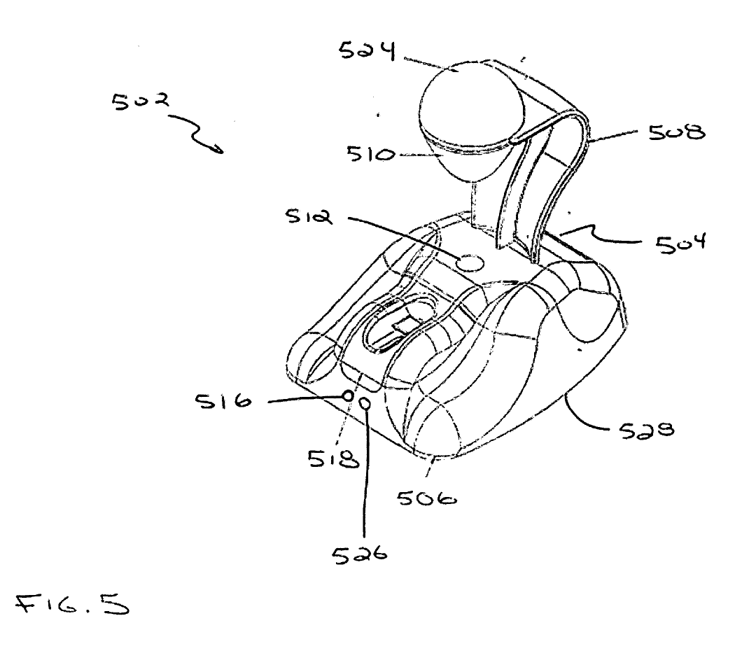

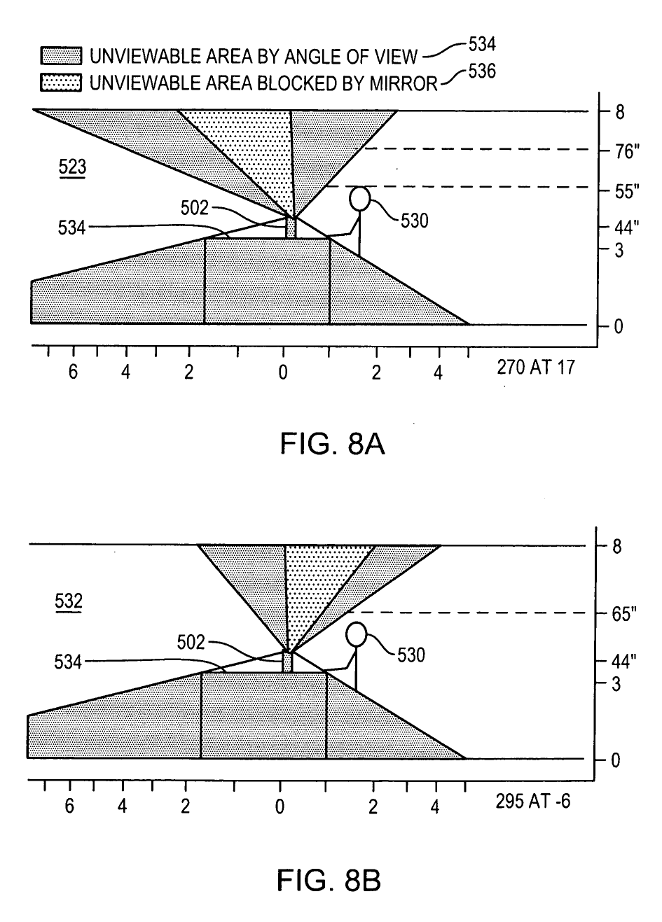

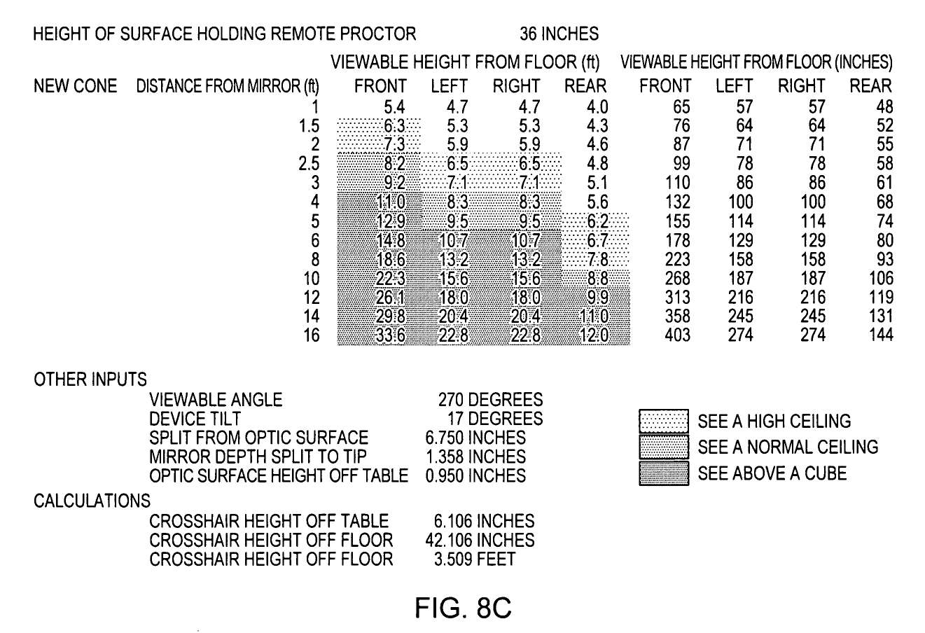

One embodiment of the remote exam monitoring device (also referred to herein as the “monitoring apparatus”) in accordance with the invention is depicted in FIGS. 5-7. The monitoring apparatus 502 collects video and audio data of the environment surrounding an exam taker (see FIGS. 8A and 8B). As shown, the monitoring apparatus 502 includes a housing 504 that includes a base 506 and an arm 508 extending generally vertically from the base 506. The arm 508 can be rigidly or flexible coupled to the base 506 by, for example, bonding, snap fit, force fit, or otherwise mechanically coupled. In one example, the arm 508 is coupled to the base 506 such that the arm is positionable, for example by sliding and/or pivoting, relative to the base 506.

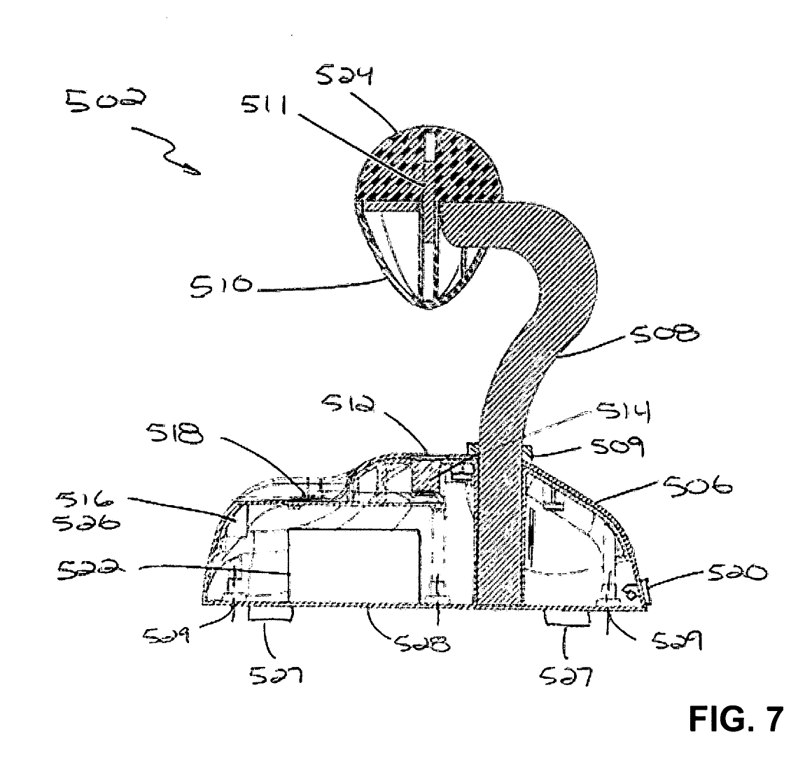

The housing 504 or portions thereof may include a rubber coating that protects the monitoring apparatus 502 and the electronic components housed therein from damage, for example if the monitoring apparatus 502 is unintentionally dropped. The base 506 may have a removable bottom cover 528 that is attached to the base 506 by screws or the like. The cover 528 can be removed to access the various components housed within the base 506. The base 506 may also include means for securing the monitoring apparatus 502 at a particular location. For example, the base 506 may include clearance holes for bolting or locking the monitoring apparatus 502 in place. Additionally or alternatively, the base 506 may include rubber feet or supports 527 (see FIG. 7) to prevent inadvertent movement of the monitoring apparatus 502. Furthermore, the base 506 can be weighted to provide additional stability to the monitoring apparatus 502.

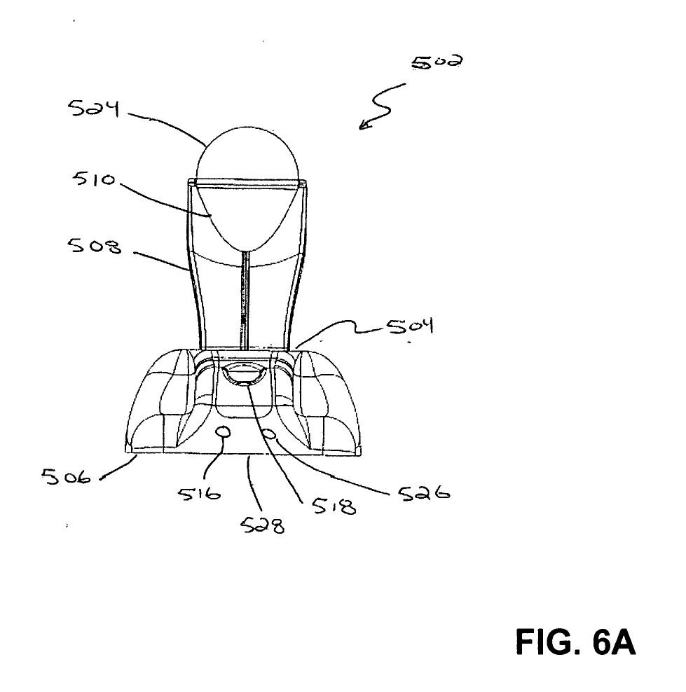

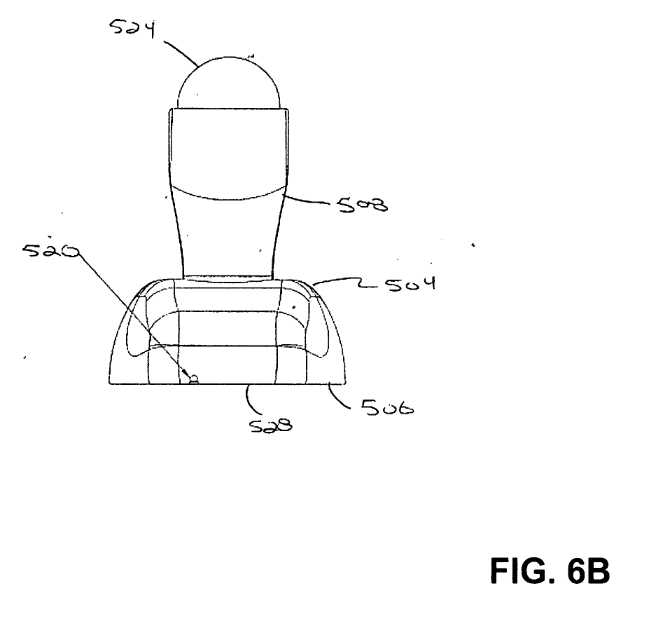

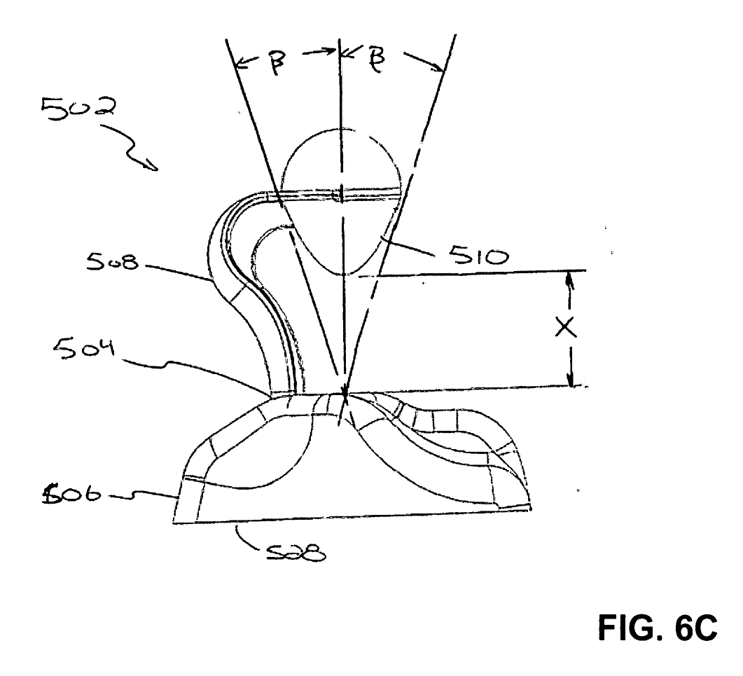

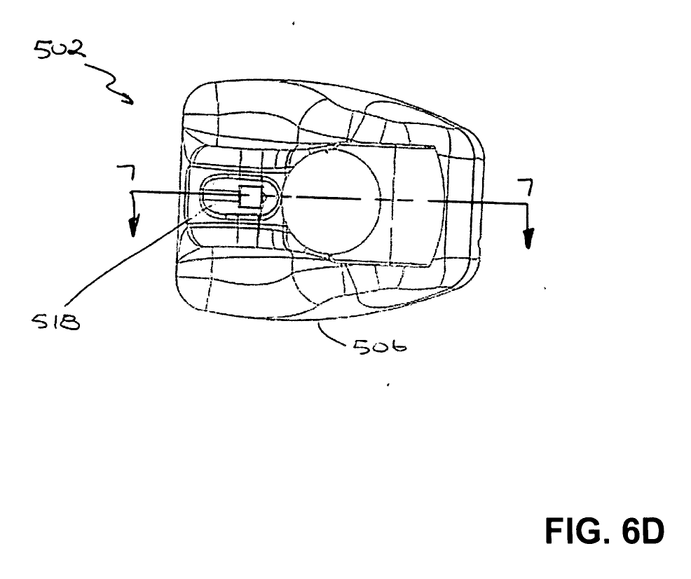

The base 506 houses both hardware and software components for authenticating the exam taker, monitoring the examination process, and, using the exam taker's client and associated Internet connection, transmitting the captured information to the examination monitoring service described above. In the embodiment shown, the base 506 houses an image capture device 514 (see FIG. 7), a lens 512, an optional microphone 516, a biometric reader 518, an optional speaker 526, a communications module 522 (see FIG. 7), and power and communication connections 520 (see FIG. 6B). In additional embodiments, the monitoring apparatus 502 may be electrically connected to a plurality of sensors that are not arranged in the housing 504 itself, but at other locations in the room or on the exam taker to further monitor the exam-taking conditions and surroundings. In addition, the monitoring apparatus 502 may include other types of input and output devices for enabling communication between the exam taker and a remote proctor, for example a keyboard and display screen.

The image capture device 514 can be a charge coupled device (CCD), a complementary metal oxide semiconductor device (CMOS), a charge injection device (CID), or a still or video camera. For example, the image capture device 514 can be a camera embedded within the device 502 such as the QUICKCAM ULTRAVISION WEB CAMERA as available from LOGICTECH, INC. of Freemont, Calif. The microphone 516 and speaker 526 enable, along with the communications module 522, two-way communication between the exam taker and the remote monitoring system and exam proctor. Similar to the camera, the microphone can be embedded within the device 502. In one embodiment, the image capture device 514 and the microphone 516 are part of a webcam. In some embodiments, the webcam contains a built-in microphone for audio capture, whereas in other applications the microphone 516 is a separate component in the base 506.

The biometric reader 518 collects biometric identifiers, which are observable biological characteristics that can be used to identify an individual, e.g., fingerprints, iris/retina patterns, facial patterns, and voice and DNA analysis. Video graphed, photographed, or scanned image(s) can be used for identification. The image(s) can be stored in digitized format in computers and ID Cards. Both for the issue and verification, the individual must be present. The process requires special purpose equipment such as, for example, a scanner, a video camera, and/or computer and card readers with the necessary matching algorithms.

The biometric reader 518 is shown disposed on a top surface of the base 506 of the monitoring device 502; however, the reader 518 could also be disposed on the sides of the base 506, on the arm 508, or as a separate component coupled to the monitoring device 502. In one embodiment, the biometric reader 518 is a fingerprint capture device such as a scanner that collects biometric information as part of the authentication process. Additionally or alternatively, the biometric reader 518 could capture such information as retina/iris patterns, voice prints, or facial patterns, as is known in the industry, to authenticate the identity of the exam taker. Various examples of biometric readers 518 include those offered by SCM MICORSYSTEMS of Freemont, Calif.

As shown in FIGS. 5-7, a mirror 510 is generally disposed at one end of the arm 508 and positioned substantially over the lens 512 and image capture device 514. The mirror 510 can be generally conical or spherical in shape to suit a particular application. In the embodiment shown, the mirror 510 has a generally convex, conical shape. The lens 512 and image capture device 514 are fixed within the base 506 and are pointed in the direction of the mirror 510. By pointing the image capture device 514 at the conical mirror 510, room-wide images can be captured. The distance (X)(see FIG. 6C) between the image capture device 514 and the mirror 510 can either be fixed or adjustable to maximize the view of the room, while considering image clarity and the overall size of unit. Additionally or alternatively, the angular position (β)(see FIG. 6C) of the mirror 510 relative to the lens 512 and image capture device 514 can be adjusted to alter the viewing angle of the monitoring area. For example, the arm 508 could be pivotably coupled to the base 506, as previously described. In an alternative embodiment, the arm 508 can be coupled to the base 506 via an actuator or other motorized connection, such that the position of the mirror 510, and thus the viewing angle, can be changed remotely. For example, a proctor at a remote location can remotely move the mirror 510 to scan the monitoring area for any irregularities.

The communications module 522 is housed within the base 506 (see FIG. 7) and can include a processor for collecting and processing data captured by the monitoring apparatus 502, memory for storing the data, and means for transmitting and/or displaying the data. The communications module, and thus the monitoring apparatus 502 may be connected to the exam taker's computer via the connection(s) 520 disposed on the rear of the monitoring apparatus 502 (see FIG. 6B). The connection 520 can be any one of a number of standard connection ports (USB, parallel, serial, firewire, wireless, etc.), thus ensuring that the monitoring apparatus 502 is portable between different computers. The monitoring apparatus 502 can be powered via its connection to the exam taker's computer or independently powered through one or more connections 520 disposed on the monitoring apparatus 502. At installation, a particular student's registration information will include in addition to their personal identification data (finger-scan, facial image, voice-print), the unique serial numbers of the hardware components that make-up the monitoring apparatus.

The assembly of the monitoring apparatus 502 is shown in greater detail in FIG. 7. As shown in FIG. 7, the arm 508 is slidably disposed within the base 506, such that the height of the mirror 510 can be changed by loosening a collar 509 disposed about the arm 508. The collar 509 can be a grommet-type fitting connected to the base 506 that holds the arm 508 in a set vertical position relative to the base 506. In an alternative embodiment where the arm 508 is pivotably mounted to the base 506, the arm 508 can be secured to a pivot pin by a similar fitting. The mirror 510 is secured to the arm 508 via a cap 524 and a pin 511. The pin 511 is force fit or otherwise attached to the cap 524. The mirror 510 is then force fit onto the pin 511 to securely fasten the mirror 510 to the cap 524, and thus the arm 508. The cap 524 can be fixed to the arm 508 or the cap and mirror assembly can be clamped onto the arm 508. Alternatively, the pin 511 could be a threaded rod, such that the mirror 510 is screwed onto the cap 524 and can be easily removed for, for example, exchanging mirrors. The monitoring apparatus 502 can come equipped with multiple mirrors 510 sized and shaped to accommodated various locations to be monitored. The various electronic components, for example the image capture device 514 and communications module 522 can be attached to the base 506 by screws, with or without support brackets, or similar mechanical means. As shown in FIG. 7, the cover 528 is removably attached to the bottom of the base 506 by fasteners 529.

The various housing components, for example the base 506 and the arm 508, can be manufactured as single plastic parts by injection molding or extrusion. Both methods lead to very low manufacturing costs, a low weight, easy adaptation to different sizes, by using correspondingly adapted molds for injection molding. In some embodiments, the components can be manufactured by multi-component injection molding more than one plastic material. For example, a harder plastic material can be used for the base 506 and a particularly elastic plastic material can be used for the arm 508. Suitable plastic materials include thermoplastic polyurethanes, polypropylene, thermoplastic olefin, and nylons. Other suitable materials will be apparent to those skilled in the art. The overall size and configuration of the monitoring apparatus 502 will vary to suit a particular application, for example, monitoring a single exam taker or a plurality of exam takers in a single room, where the monitoring apparatus 502 may include multiple image capture devices 514 and mirrors 510. Generally, the monitoring apparatus 502 is sized and configured for mounting on a desktop.

FIGS. 8A and 8B depict two examples of the viewable and non-viewable area of the exam-taking environment 532. The exam taker 530 is typically located at a desk or other type of work station 534, with the monitoring apparatus 502 located proximate the exam taker 530. The viewable area can be altered by, for example moving the mirror towards or away from the image capture device 514. The mirror position can be changed by, for example, sliding the arm 508 vertically relative to the base 506. The farther the mirror is positioned from the image capture device 514, the larger the viewing area becomes; however, enlarging the viewing area may cause the image quality to degrade. As shown in FIG. 8A, the mirror 510 is positioned over a 36″ table top, and has a 270 degree view with a 17 degree tilt, resulting in a viewable area as depicted therein. In FIG. 8B, the mirror is positioned over a 36″ table top, and has a 295 degree view with a −6 degree tilt, resulting in a viewable area as depicted therein. The size and shape of the mirror 510 will also affect the viewable area. For example, the greater the conical angle of the mirror, the greater the viewing area reflected to the image capture device.

Other parameters that impact the field of view of the camera include the height of the camera off of the floor or table, the distance between the mirror and the camera, and the curvature of the camera. For example, some embodiments may use a spherical mirror and thus increase the degree view (e.g., >300 degrees). However, the need to maintain a sufficient number of pixels along the image boundaries and the desire to minimize distortion may cause the optimal mirror positioning to be such that a smaller field of view is available. The ability to adjust the mirror height and position allows users to regulate the area that is viewable by the device.

FIG. 8C illustrates a table of viewable heights given various arrangements of the device sitting atop a 36 inch high table, with a viewable angle Aᵥ of 270 degrees and a 17 degree tilt t from vertical. In this particular example, the device is sized such that the “crosshair” of the mirror is 6.106 inches above the table, and therefore 42.106 inches (or 3.509 feet) off of the floor (H), and the camera is approximately 0.95 inches off of the table. The mirror is configures such that the depth of the mirror from the end of the parabola of the convex mirror (e.g., the “base” of the cone) to its tip is 1.358 inches, and therefore 6.75 inches from the camera. The viewable height from the floor at a given distance D from the device in front of the device VH_{f} is calculated according to equation (1) below:

$$H + ( D \times tan ( ( ( ( \frac{{A}_{v} - 180}{2} ) + t ) \times \frac{π}{180} ) ) ) . \qquad Equation ( 1 )$$

Similarly, the viewable height from the floor at a given distance D from the device behind the device VHᵣ is calculated according to equation (2) below:

$$H + ( D \times tan ( ( ( ( \frac{{A}_{v} - 180}{2} ) - t ) \times \frac{π}{180} ) ) ) . \qquad Equation ( 2 )$$

Using the results of Equations (1) and (2) the viewable height form the floor to the left or right of the device VHₛ , can be calculated by averaging the two values using equation (3):

$$VHs = \frac{VHf + VHr}{2} . \qquad Equation ( 3 )$$

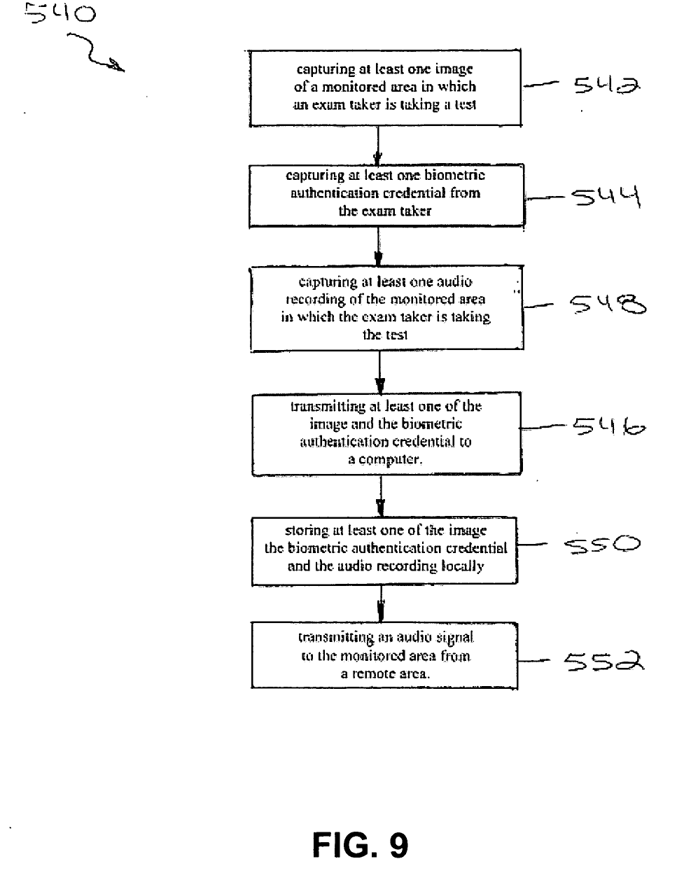

FIG. 9 depicts one embodiment of a method of remotely monitoring the administration of an exam. As shown, the method 540 includes the steps of capturing at least one image of the monitored area, step 542, capturing at least one biometric authentication credential from the exam taker, step 544, and transmitting at least one of the image and the biometric authentication credential to a computer, step 546. Typically, the area is monitored on a regular basis with the images transmitted continuously or periodically to a computer and/or a remote proctor. The biometric authentication information is typically sent prior to beginning the test in order to verify the correct exam taker is present. The information may be requested and transmitted to the computer and/or remote proctor at intermittent periods during the exam to further verify that the correct exam taker is taking the exam. Optionally, the audio in the monitored area can also be captured, step 548, in which case the audio recording(s) can also be transmitted to the computer or remote proctor via step 546. The captured data can be stored remotely or locally for later review. In a particular embodiment, the monitoring apparatus 502 includes memory for storing the data locally, step 550. In addition, audio signals, such as instructions, alarms, or requests for data can be transmitted to the monitored environment from the remote location via the monitoring apparatus 502, step 552.

The invention may be embodied in other specific forms without departing from the spirit or essential characteristics thereof. The foregoing embodiments, therefore, are to be considered in all respects illustrative rather than limiting the invention described herein. Scope of the invention is thus indicated by the appended claims, rather than by the foregoing description, and all changes that come within the meaning and range of equivalency of the claims are intended to be embraced therein.

What is claimed is:

1. A method for administering an exam at a remote location, the method comprising:
providing a set of rules governing the distribution and administration of an exam;
assigning a proctor to the exam;
providing the exam to one or more exam takers, at least one of the exam takers being located remotely from the assigned proctor;
authenticating the one or more exam takers as approved exam takers; and
during execution of the exam by the exam takers, providing data indicative of the environment of the exam takers to the proctor, thereby allowing the proctor to monitor the actions and environment of the one or more exam takers.

2. The method of claim 1 further comprising storing the data indicative of the environment of the exam takers in a central data store.

3. The method of claim 1 further comprising providing a remote exam monitoring device to the one or more exam takers wherein the remote exam monitoring device collects the data environment of the actions of the exam takers.

4. The method of claim 3 wherein the remote exam monitoring device comprises a video camera.

5. The method of claim 3 wherein the remote exam monitoring device comprises a microphone.

6. The method of claim 3 wherein the remote exam monitoring device comprises a still image camera.

7. The method of claim 1 wherein the data indicative of the environment of the exam takers is provided in real-time.

8. The method of claim 1 wherein the data indicative of the environment of the exam takers is provided continuously.

9. The method of claim 1 wherein the data indicative of the environment of the exam takers is provided periodically.

10. The method of claim 9 wherein the data indicative of the environment of the exam takers is provided in response to a trigger event.

11. The method of claim 10 wherein the trigger event comprises an action by the one or more exam takers.

12. The method of claim 10 wherein the trigger event comprises an event occurring within the environment of the one or more exam takers.

13. The method of claim 10 wherein the trigger event comprises an event occurring outside the environment of the one or more exam takers.

14. The method of claim 10 wherein the trigger event comprises an indication from the exam proctor that data indicative of the environment of the exam takers is to be captured.

15. The method of claim 1 wherein the authentication comprises provision of a biometric credential.

16. The method of claim 1 wherein the authentication comprises provision of an authentication token.

17. The method of claim 1 further comprising assigning the proctor to additional exams, thereby allowing the proctor to administer more than one exam simultaneously.

18. The method of claim 1 wherein the exam is administered on a computer.

19. The method of claim 18 wherein the computer is owned by the exam taker.

20. The method of claim 18 further comprising receiving log files from the computer, the log files describing the actions taken on the computer during the execution of the exam.

21. The method of claim 1 further comprising annotating the data indicative of the environment of the exam takers.

22. The method of claim 1 further comprising analyzing the data indicative of the environment of the exam takers to determine whether improprieties occurred during the administration of the examination.

23. A system for remotely administering an examination, the system comprising:
an examination authentication services module for authenticating users of the system;
an examination builder module for defining exam rules and exam meta data and for providing an examination to one or more remote exam takers in response to a request for an examination and upon authentication of the exam takers; and
an examination monitoring services module for receiving data indicative of the environment of the remote exam takers, thereby allowing an exam proctor to administer the exam from a location other than that of the remote exam takers.

24. The system of claim 23 further comprising a data storage module for storing the received data.

25. The system of claim 24 wherein the data storage module further stores the exam rules and exam meta data.

26. The system of claim 23 further comprising an exam analysis services module for analyzing the received data to detect improprieties during the administration of the examination.

27. The system of claim 23 further comprising a remote exam monitoring device for collecting the data indicative of the environment of the remote exam takers.
